(19) United States
(12) Patent Application Publication
(10) Pub. No.: US 2026/0093637 A1
(43) Pub. Date: Apr. 2, 2026

(54) TRACKING ACCESSES TO A MEMORY USING A RING-BUFFER STRUCTURE

(71) Applicant: Micron Technology, Inc., Boise, ID (US)

(72) Inventors: Massimiliano TURCONI, Gorgonzola (IT); Danilo CARACCIO, Milano (IT); Alessandro ORLANDO, Milano (IT)

(21) Appl. No.: 19/291,804

(22) Filed: Aug. 6, 2025

Related U.S. Application Data
(60) Provisional application No. 63/701,324, filed on Sep. 30, 2024.

(51) Int. Cl. G06F 12/123; G06F 12/0831; G06F 13/16

(52) U.S. Cl. CPC G06F 12/123; G06F 12/0833; G06F 13/1673

(57) ABSTRACT

In some implementations, a memory system controller may receive, from a host system, a memory-access request. The memory system controller may store an identifier associated with the memory-access request in a ring-buffer structure. The memory system controller may determine whether a data structure includes an entry associated with the identifier. The memory system controller may perform one of: updating a memory-access counter stored at the entry when the data structure does include the entry, or creating the entry in the data structure and initializing the memory-access counter stored at the entry when the data structure does not include the entry. The memory system controller may receive, from the host system, a request to read the data structure and/or may transmit, to the host system and based on the request, an indication of a respective identifier and a respective memory-access counter for each entry having a respective flag set.

### TECHNICAL FIELD

The present disclosure generally relates to memory systems, memory system operations, and, for example, to tracking accesses to a memory using a ring-buffer structure.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source. In some examples, a memory device may be associated with a compute express link (CXL) protocol and/or a CXL compliant memory system.

### BRIEF DESCRIPTION OF THE DRAWINGS

FIG. 1 is a diagram illustrating an example system capable of tracking accesses to a memory using a ring-buffer structure.

FIG. 2 is a diagram illustrating another example system capable of tracking accesses to a memory using a ring-buffer structure.

FIGS. 3A-3G are diagrams of an example of tracking accesses to a memory using a ring-buffer structure.

FIG. 4 is a flowchart of an example method associated with tracking accesses to a memory using a ring-buffer structure.

### DETAILED DESCRIPTION

Proper management of memory resources may be important for sustaining efficient memory system performance and scalability, such as in connection with large-scale data-center operations or similar operations. In some examples, memory-based applications require high memory capacities, prompting a push for tiered memory system topologies and similar memory solutions. These tiered memory system topologies and/or similar solutions may combine dynamic random access memory (DRAM) with high-capacity volatile memories and slower, non-volatile memories to balance cost and performance. For example, an emerging standard known as compute express link (CXL) may facilitate advanced memory configurations by enabling scalable interconnects that allow efficient resource sharing and system-level optimization.

However, as system architectures evolve, a challenge persists in effectively managing these complex memory hierarchies. Specifically, the optimization of memory utilization through the strategic placement of “hot” (e.g., frequently accessed) and “cold” (e.g., infrequently accessed) memory pages has become a focal point to reduce the total cost of ownership (TCO) of memory systems and/or to enhance memory system performance. Identifying hot and cold pages may be needed for enabling smart data migration within the tiered memory systems, helping to improve the user experience and accommodate workloads such as artificial intelligence (AI), machine learning (ML), analytics, and/or high-performance computing (HPC), among other examples.

Existing techniques to identify and manage hot and cold pages face certain limitations. Software approaches, such as those at the operating system (OS) and/or hypervisor level, often require intricate, application-specific tuning, presenting challenges in terms of scalability and leading to a tradeoff between identification resolution and performance impact. On the other hand, hardware-based profiling and sampling methods may impact central processing unit (CPU) performance. Thus, these approaches may not provide an optimal solution for dynamic and efficient memory access monitoring within the ever-growing and diversifying landscapes of data center environments.

Some implementations described herein improve the management of memory resource utilization in data center operations and/or other application through a queue-based hot data detection mechanism, such as a queue-based hot data detection mechanism within a CXL compliant memory system or a similar memory system. In some implementations, a memory system controller (e.g., a CXL controller and/or a CXL application specific integrated circuit (ASIC), among other examples) may receive a memory-access request (e.g., from a host system, such as a CXL host or a similar host system), and the memory system controller may align the request to an identifier (ID) (sometimes referred to herein as a page ID) and/or may store the ID with that request in a ring-buffer structure. In some implementations, the memory system controller may maintain a data structure (sometimes referred to herein as a hotlist) that is separate from the ring-buffer structure, such as for a purpose of storing access counters (e.g., hotness counters) associated with various page IDs. In such implementations, the memory system controller may determine if the data structure associated with the ring-buffer includes an existing entry for the page ID associated with the incoming request. If the data structure includes an existing entry for the page ID, the memory system controller may update (e.g., increment) a memory-access counter for the existing entry, accordingly. On the other hand, if the data structure does not include an existing entry, the memory system controller may create a new entry in the data structure for the page ID, and the memory system controller may initialize a memory-access counter (e.g., set to 1) at the new entry. In some implementations, after updating a corresponding memory-access counter for the page ID in the data structure (e.g., the hotlist), the memory system controller may determine if the memory-access counter satisfies a threshold (sometimes referred to herein as a hotness threshold). If the threshold is satisfied, the memory system controller may set a bit (sometimes referred to herein as a hot flag) in the entry to indicate that the corresponding memory location is hot, and/or the memory system controller may periodically transmit an indication of any pages for which a hot flag has been set to the host system.

In this way, the techniques described herein may enable conservation of memory resources by facilitating intelligent memory access tracking and hot data identification with minimal processing overhead. The deterministic methodology of the memory system controller may ensure that all memory-access requests are evaluated for hotness, which may optimize memory page prioritization and placement. In some implementations, the queue-based approach may reduce latency and/or enhance efficiency for handling frequent memory accesses, thereby decreasing the overall memory footprint and/or reducing the cost associated with memory resources in tiered memory architectures. In some implementations, by improving the efficiency of memory utilization and page management, the techniques described herein may mitigate the need for additional memory capacity expansions, leading to a more sustainable data center environment with optimized resource allocation for high-demand applications such as AI, ML, analytics, and/or HPC workloads, among other examples. The techniques described herein may enable performance of this functionality without placing additional computational strain on the host system, reflecting an advancement in memory technology that supports growing scalability demands and ensures a reduction in TCO for data center operations and/or similar applications.

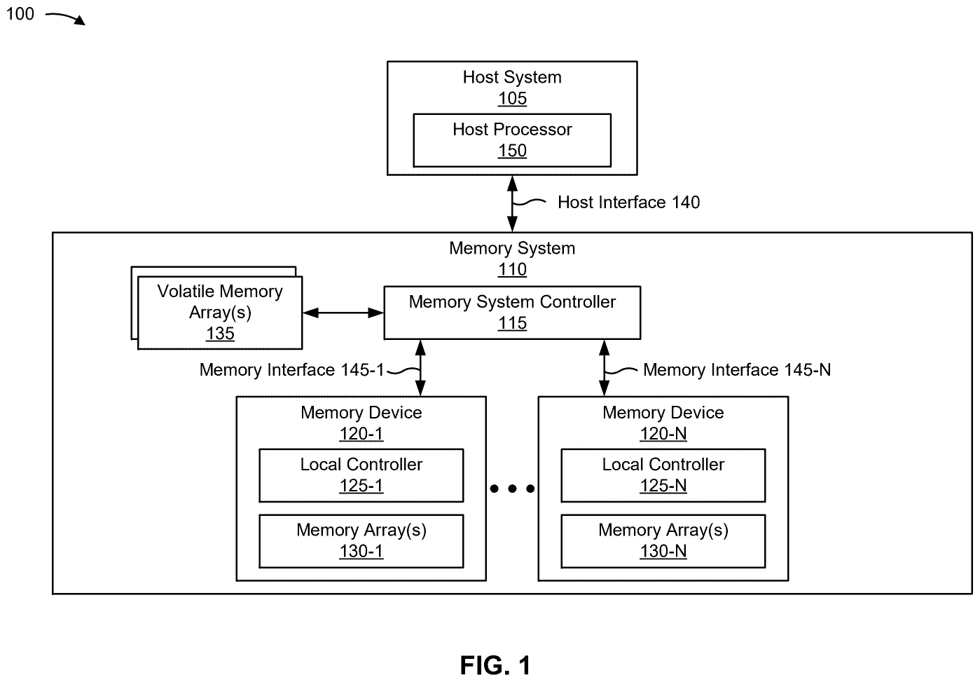

FIG. 1 is a diagram illustrating an example system 100 capable of tracking accesses to a memory using a ring-buffer structure. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a CPU, a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), a CXL memory module, and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, a CXL controller connected to DRAM, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off, and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

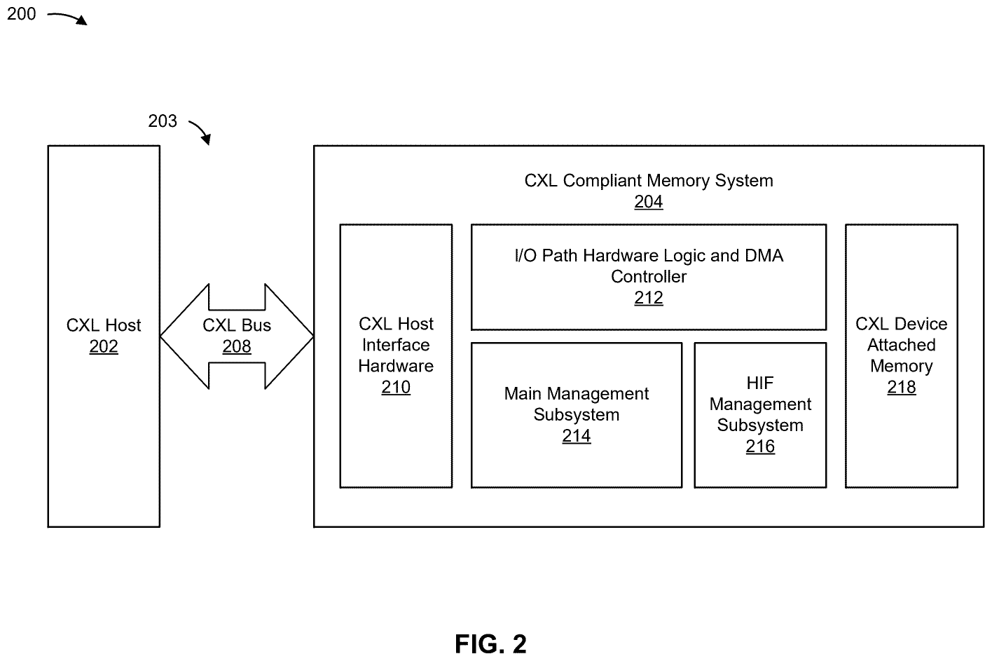

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, a DIMM interface, and/or a CXL interface (e.g., a PCIe/CXL interface, described in more detail below in connection with FIG. 2).

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to receive, from a host system, a memory-access request associated with a memory of a memory system; store an identifier associated with the memory-access request in a ring-buffer structure; determine whether a data structure associated with the ring-buffer structure includes an entry associated with the identifier; and perform one of: update a memory-access counter stored at the entry in response to determining that the data structure includes the entry, or create the entry in the data structure and initializing the memory-access counter stored at the entry in response to determining that the data structure does not include the entry.

In some implementations, one or more systems, devices, apparatuses, components, and/or controllers of FIG. 1 may be configured to receive, from a host system, a CXL.mem request associated with a memory of the CXL compliant memory system; store a page ID associated with the CXL.mem request in a ring-buffer structure; determine whether a hotlist associated with the ring-buffer structure includes an entry associated with the page ID; and perform one of: update a hotness counter stored at the entry in response to determining that the hotlist includes the entry, or create the entry in the hotlist and initialize the hotness counter stored at the entry in response to determining that the hotlist does not include the entry.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

FIG. 2 is a diagram illustrating another example system 200 capable of tracking accesses to a memory using a ring-buffer structure. The system 200 may include one or more devices, apparatuses, and/or components for performing operations described herein. In some examples, the system 200 may be associated with a CXL standard and/or protocol (e.g., the system 200 may utilize a CXL protocol to communicate between a host device, sometimes referred to as a CXL compliant host or simply a CXL host, and a memory system, sometimes referred to as a CXL compliant memory system or simply a CXL memory system). In that regard, the system 200 may include a CXL host 202 (which may correspond to the host system 105) and a CXL compliant memory system 204 (which may correspond to the memory system 110). The CXL host 202 and the CXL compliant memory system 204 may communicate via an interface 203 (e.g., host interface 140), which may include a CXL bus 208 (e.g., a PCIe/CXL interface), among other examples.

In some examples, the CXL compliant memory system 204 may be a system that complies with the CXL standard and/or protocol, such as for a purpose of communicating with one or more host devices (e.g., a CXL compliant host, such as CXL host 202). CXL is an open standard that may enable high-speed CPU-to-device and CPU-to-memory interconnects designed to accelerate next-generation performance. The CXL standard may enable memory coherency between the CPU memory space and memory on attached devices, which allows resource sharing for higher performance, reduced software stack complexity, and lower overall system cost. CXL is designed to be an industry open standard for enabling an interface for high-speed communications. CXL technology utilizes the PCIe infrastructure, leveraging PCIe physical and electrical interfaces to provide an advanced protocol in areas such as input/output (I/O) protocol, memory protocol, and coherency interface.

In some examples, the system 200 may include a PCIe/CXL interface (e.g., the CXL bus 208 may be associated with a PCIe/CXL interface), which may be a physical interface configured to connect the CXL compliant memory system 204 to CXL compliant host devices, such as the CXL host 202. In such examples, the PCIe/CXL interface may comply with CXL standard specifications for physical connectivity, ensuring broad compatibility and ease of integration into existing systems using the CXL protocol. Additionally, or alternatively, the CXL compliant memory system 204 may be designed to efficiently interface with computing systems (e.g., CXL host 202 and/or a host system 105) by leveraging the CXL protocol. For example, the CXL compliant memory system 204 may be configured to utilize high-speed, low-latency interconnect capabilities of CXL, such as for a purpose of making the CXL compliant memory system 204 suitable for high-performance computing, data center applications, artificial intelligence (AI) applications, and/or similar applications.

In some examples, the CXL compliant memory system 204 may include a CXL memory system controller (e.g., a CXL ASIC, which may correspond to the memory system controller 115 and/or local controller 125), which may be configured to manage data flow between memory arrays (shown as CXL device attached memory 218, which may correspond to the volatile memory arrays 135 and/or the memory arrays 130) and a CXL interface (e.g., the CXL bus 208). In some examples, the CXL memory system controller may be configured to handle one or more CXL protocol layers, such as an I/O layer (e.g., a layer associated with a CXL.io protocol, which may be used for purposes such as device discovery, configuration, initialization, I/O virtualization, direct memory access (DMA) using non-coherent load-store semantics, and/or similar purposes); a cache coherency layer (e.g., a layer associated with a CXL.cache protocol, which may be used for purposes such as caching host memory using a modified, exclusive, shared, invalid (MESI) coherence protocol, or similar purposes); or a memory protocol layer (e.g., a layer associated with a CXL.memory (sometimes referred to as CXL.mem) protocol, which may enable a CXL memory device to expose host-managed device memory (HDM) to permit a host device to manage and access memory similar to a native DDR connected to the host); among other examples.

The CXL compliant memory system 204 may further include and/or be associated with one or more high-bandwidth memory modules (HBMMs) or similar memory arrays (e.g., CXL device attached memory 218). For example, the CXL compliant memory system 204 may include multiple layers of DRAM (e.g., stacked and/or interconnected through advanced through-silicon via (TSV) technology) in order to maximize storage density and/or enhance data transfer speeds between memory layers. Additionally, or alternatively, the CXL compliant memory system 204 (e.g., a CXL ASIC of the CXL compliant memory system 204) may include a power management unit, which may be configured to regulate power consumption associated with the CXL compliant memory system 204 and/or which may be configured to improve energy efficiency for the CXL compliant memory system 204. Additionally, or alternatively, the CXL compliant memory system 204 (e.g., a CXL ASIC of the CXL compliant memory system 204) may include additional components, such as one or more error correction code (ECC) engines, such as for a purpose of detecting and/or correcting data errors to ensure data integrity and/or improve the overall reliability of the CXL compliant memory system 204. The CXL compliant memory system 204 may be implemented using a combination of hardware and firmware blocks and/or components. In such examples, the firmware may execute on one or more embedded CPUs within the CXL compliant memory system 204.

Additionally, or alternatively, the CXL compliant memory system 204 and/or a CXL memory system controller (e.g., a CXL ASIC) of the CXL compliant memory system 204 may include CXL host interface hardware 210, an I/O path hardware logic and DMA controller 212, a main management subsystem 214, and/or a host interface (HIF) management subsystem 216, among other examples. In some examples, the CXL host interface hardware 210 may be hardware components that enable physical connectivity between the CXL compliant memory system 204 and one or more external devices, such as to the CXL host 202 via the CXL bus 208. In some examples, the CXL host interface hardware 210 may include the necessary physical interfaces and protocol logic required to establish and/or maintain communication over the CXL link (e.g., via the CXL bus 208). In some cases, the CXL host interface hardware 210 may ensure that the CXL host 202 can access and/or control the CXL compliant memory system 204 efficiently.

The I/O path hardware logic and DMA controller 212 may handle data transfers between the CXL compliant memory system 204 and external devices, such as other memory modules and/or peripheral components. In some examples, a DMA controller portion of the I/O path hardware logic and DMA controller 212 may permit efficient data transfer without involving a CXL compliant memory system 204 CPU, directly. Put another way, the DMA controller portion of the I/O path hardware logic and DMA controller 212 may manage data movement between the CXL compliant memory system 204 and other system components, which may enhance overall system performance by offloading data transfer tasks from the CPU.

The main management subsystem 214 may serve as a central control and management unit within the CXL compliant memory system 204. In some examples, the main management subsystem 214 may encompass various functionalities and tasks, such as memory access control, error detection and/or correction, power management, and/or similar system management functionalities and/or tasks. Additionally, or alternatively, the main management subsystem 214 may ensure proper functioning and/or reliability of the CXL compliant memory system 204 and/or may optimize the performance of the CXL compliant memory system 204 under various operating conditions.

The HIF management subsystem 216 may be responsible for managing and/or controlling the CXL host interface hardware 210, among other tasks. In some examples, the HIF management subsystem 216 may handle tasks related to link initialization configuration negotiation with the CXL host 202, error handling, and/or other protocol-specific functionalities. Additionally, or alternatively, the HIF management subsystem 216 may ensure smooth communication between the CXL compliant memory system 204 and/or the CXL host 202, such as by maintaining compatibility and/or reliability of the CXL link, among other examples.

In some examples, the CXL compliant memory system 204 may be categorized as a CXL type 1 device, a CXL type 2 device, or a CXL type 3 device. A CXL type 1 device may be a device that implements a coherent cache using the CXL.cache protocol. A CXL type 2 device may be a device that implements both a coherent cache using the CXL.cache protocol and a host-managed device memory using the CXL.mem protocol. For example, a CXL type 2 device may be a hardware accelerator device. A CXL type 3 device may be a device that implements a host-managed device memory using the CXL.mem protocol. For example, a CXL type 3 device may be a memory expander device.

The number and arrangement of components shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, distributed components. Additionally, or alternatively, a set of components (e.g., one or more components) shown in FIG. 2 may perform one or more operations described as being performed by another set of components shown in FIG. 2.

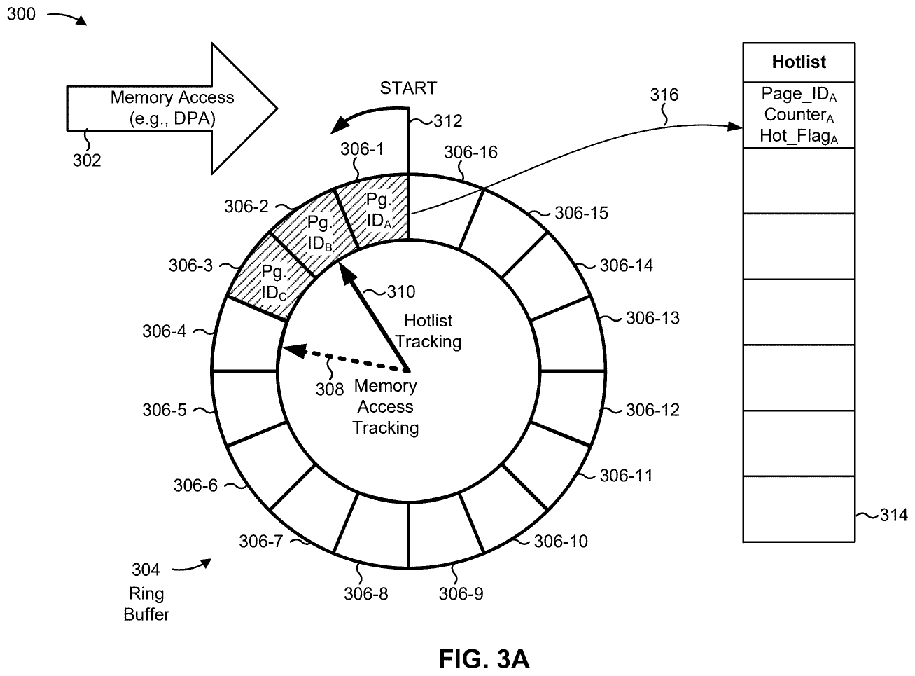

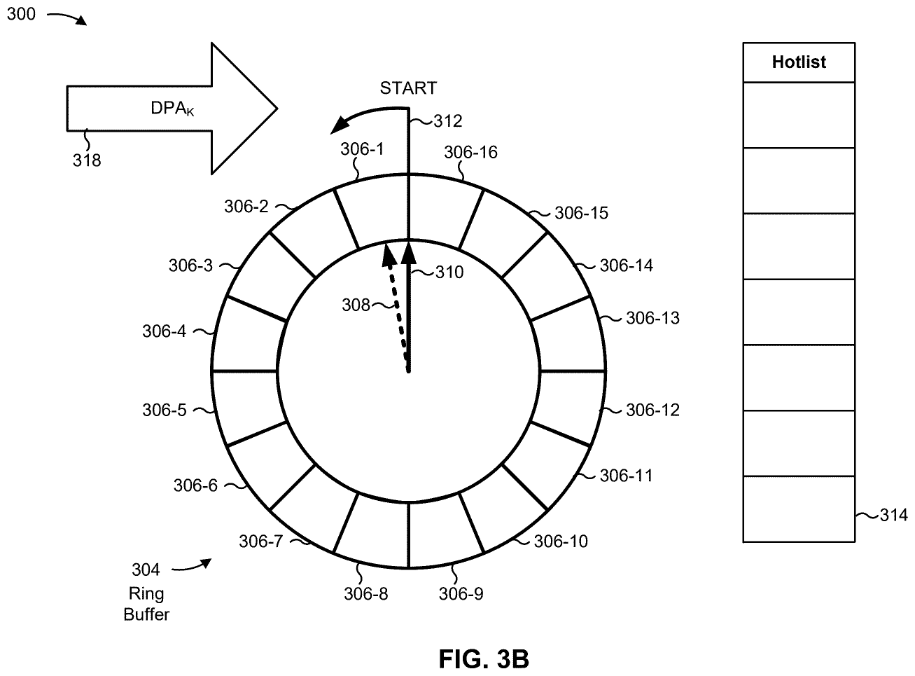

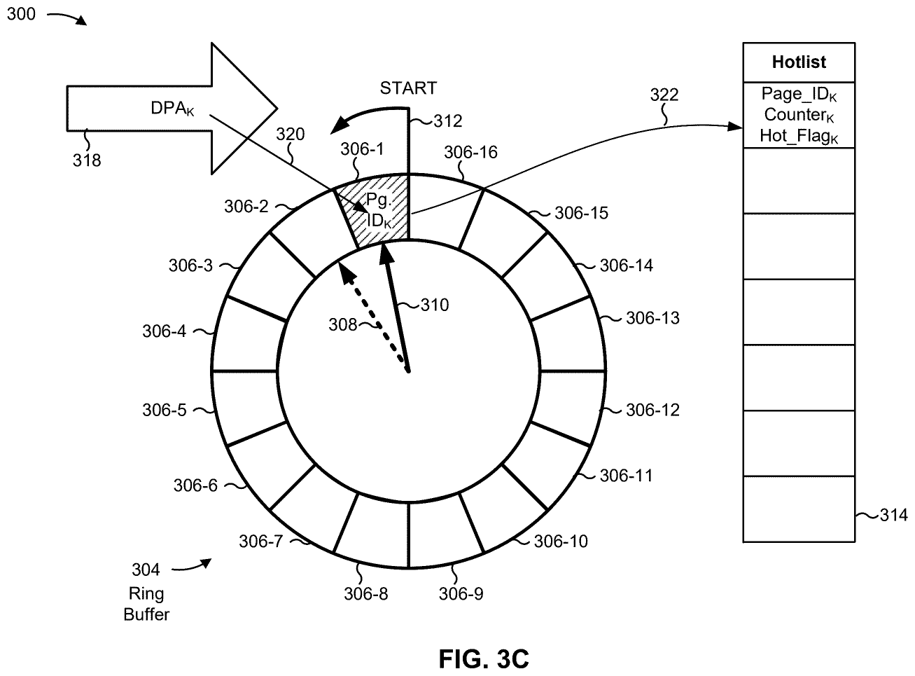

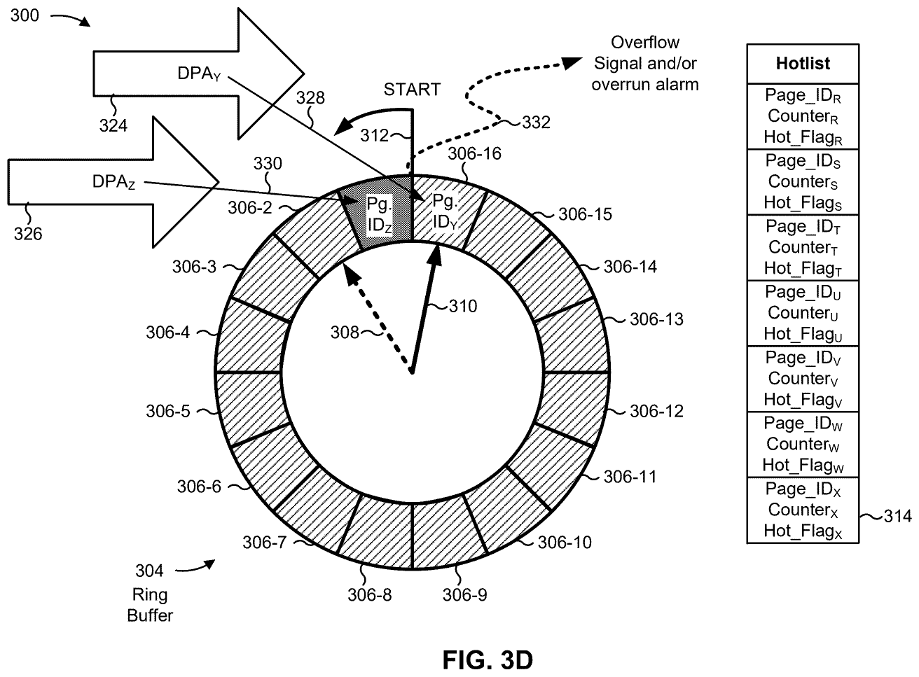

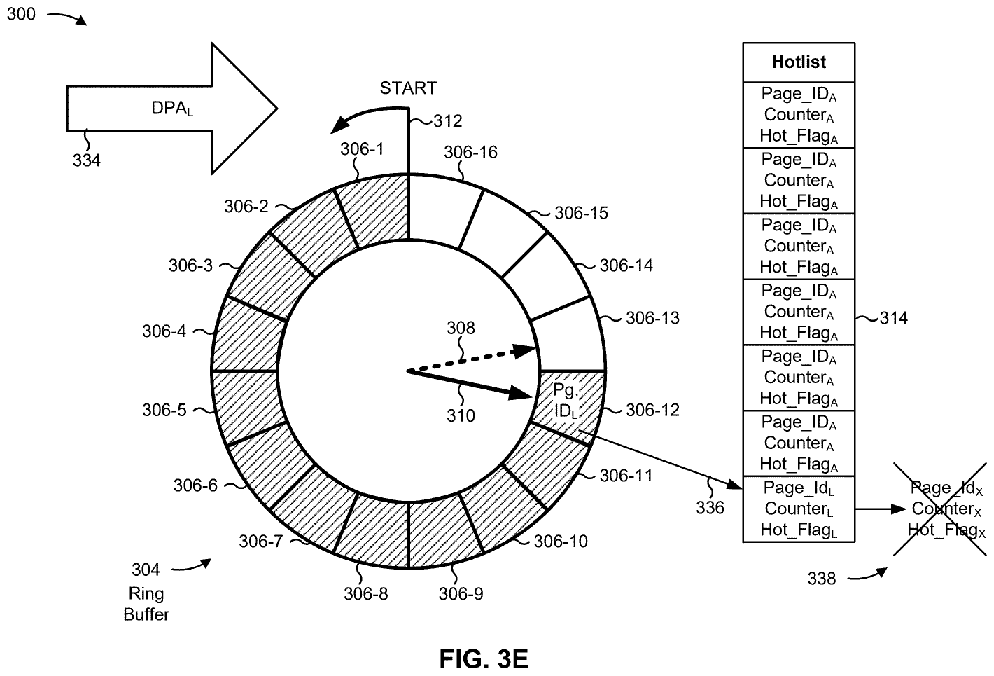

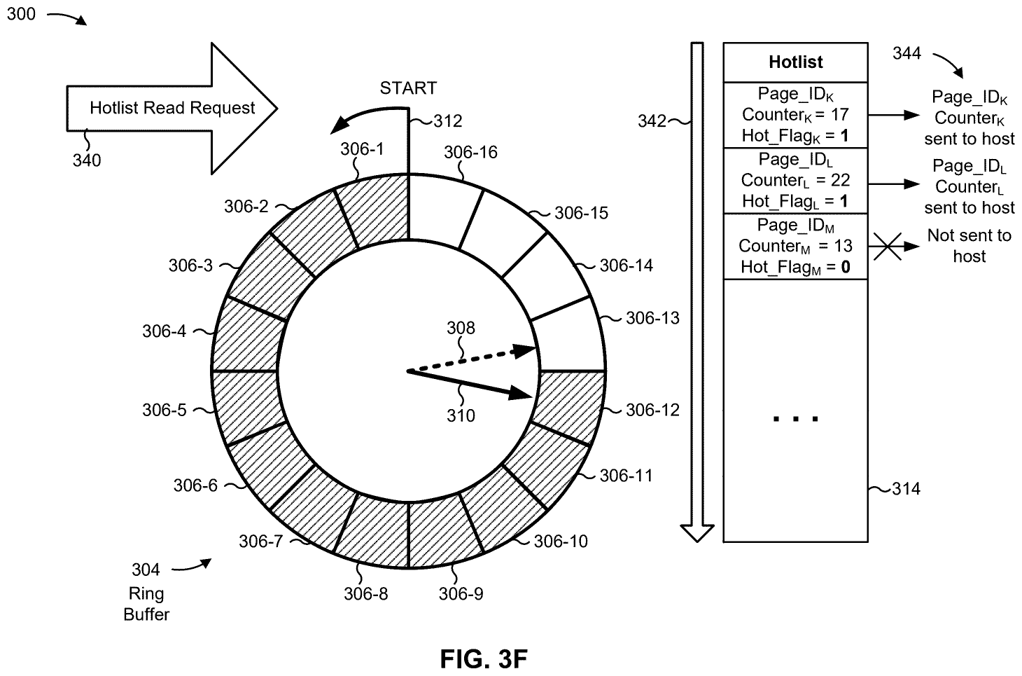

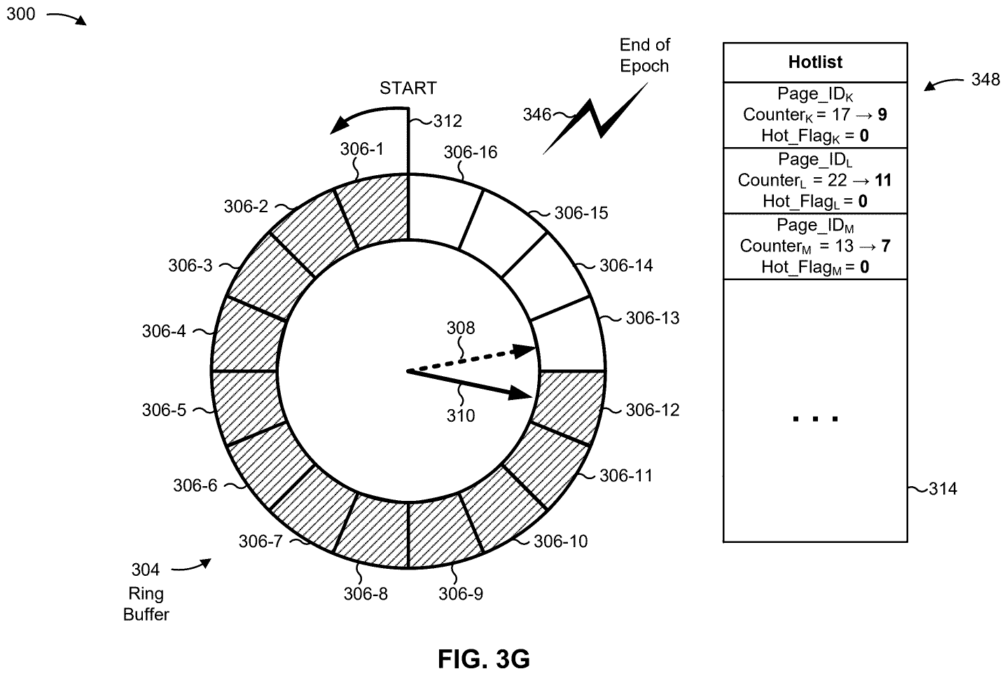

FIGS. 3A-3G are diagrams of an example 300 of tracking accesses to a memory using a ring-buffer structure. The operations described in connection with FIGS. 3A-3G may be performed by the memory system 110 and/or one or more components of the memory system 110, such as the memory system controller 115, one or more memory devices 120, and/or one or more local controllers 125, and/or the CXL compliant memory system 204 and/or one or more components of the CXL compliant memory system 204, such as a main management subsystem 214, the CXL device attached memory 218, and/or one or more local controllers associated with the CXL device attached memory 218.

As shown in FIG. 3A, example 300 includes a memory system (not shown in connection with the example 300 for ease of description, but which, in some implementations, corresponds to the memory system 110 and/or the CXL compliant memory system 204) receiving, from a host system (not shown in connection with the example 300 for ease of description, but which, in some implementations, corresponds to the host system 105 and/or the CXL host 202) a memory-access request 302 (e.g., a CXL.mem request, such as a read request, a write request, and/or a similar request). Upon receiving the memory-access request 302, the memory system may associate the request with a portion of memory in the memory system (e.g., a portion of the memory to be written to and/or to be read), such as by aligning the request to an identifier (e.g., a page ID) according to a configured tracking granularity. Put another way, incoming memory-access requests (which are sometimes referred to herein as incoming device physical addresses (DPAs), with a DPA corresponding to a portion of the memory that may be accessed during a single memory access by the memory system controller) may be aligned to a page ID corresponding to a configured tracking granularity. In that regard, in implementations in which the memory system is configured to track memory accesses at a granularity that is equal to or greater than a size of a DPA, the memory system may align each incoming memory-access request to a single page ID. In implementations in which the memory system is configured to track memory accesses at a granularity that is smaller than a size of a DPA, the memory system may align each incoming memory-access request to multiple page IDs.

In some implementations, the memory system may track memory accesses using a ring-buffer structure 304. Put another way, the memory system may store page IDs associated with incoming memory-access requests (e.g., memory-access request 302 and/or similar requests) using the ring-buffer structure 304, with the ring-buffer structure 304 including multiple portions 306 (shown in FIG. 3A as a first portion 306-1 through a sixteenth portion 306-16, but which may include more or fewer portions in other implementations). In such implementations, each page ID associated with the memory-access request 302 may be stored in the ring-buffer structure 304, and, more particularly, in a corresponding portion 306 of the ring-buffer structure 304.

In some implementations, the ring-buffer structure 304 may be managed using one or more pointers (sometimes referred to herein as cursors), including a memory-access pointer 308 (sometimes referred to herein as a DPA tracking pointer and/or cursor) and a data-structure pointer 310 (sometimes referred to herein as a hotlist tracking pointer and/or cursor), among other examples. The memory-access pointer 308 and/or the data-structure pointer 310 may start at the start position 312 and/or may move around the ring-buffer structure 304 as page IDs are added to the ring-buffer structure 304 (more particularly, to respective portions 306 of the ring-buffer structure 304) and/or as the page IDs stored in the ring-buffer structure 304 are tracked using a data structure 314 (e.g., a hotlist). In this way, at any given time, the memory-access pointer 308 may point to the first available entry (e.g., portion 306) in the ring-buffer structure 304 for storing a current page ID (e.g., a page ID associated with an incoming memory-access request 302) and/or the data-structure pointer 310 may point to the last element scanned for building the data structure 314 (e.g., the hotlist). Put another way, the memory-access pointer 308 may be utilized to identify the next available entry within the ring-buffer structure 304 for an incoming page ID associated with a memory-access request, and/or the data-structure pointer 310 may be employed to denote the most recently analyzed portion of the ring-buffer structure 304 containing a page ID that has been scanned for counting and adding to the data structure 314.

As shown by the arrow indicated by reference number 316, as memory-access requests 302 are received at the memory system, page ID occurrences may be counted and saved in a fully associative structure (e.g., the data structure 314), which may include multiple entries, such as one for each of multiple page IDs being tracked. In such implementations, each entry may include an associated page ID, a memory-access counter (sometimes referred to herein as a hotness counter), and/or a flag (sometimes referred to herein as a hot flag). In such implementations, the memory-access counter may correspond to a quantity of accesses made to the page ID indicated in the entry during a given time period (sometimes referred to herein as an epoch), and/or the flag may be a one-bit flag that is used to identify if the quantity of accesses to the portion of the memory corresponding to the page ID satisfies a threshold (e.g., a hotness threshold). That is, the hot flag may be a one-bit flag used to identify whether a corresponding page ID is hot. In such implementations, every time a memory-access counter is updated in a given entry, the memory-access counter may be compared against a threshold (e.g., a hotness threshold), and, if the memory-access counter satisfies the threshold, the corresponding flag (e.g., the corresponding hot flag) may be set to “1”.

In that regard, for a given incoming memory-access request 302, the memory system may align the DPA with a page ID and store the page ID in a portion 306 of the ring-buffer structure 304 that is pointed to by the memory-access pointer 308. Then, when the data-structure pointer 310 advances to that specific portion 306 of the ring-buffer structure 304, the memory system may determine if the data structure 314 (e.g., the hotlist) already has an entry corresponding to the Page ID associated with the memory-access request 302. If an entry already exists in the data structure 314, the memory system may update (e.g., increment) the corresponding memory-access counter stored at the entry. On the other hand, if no entry exists, the memory system may create a new entry in the data structure 314 and/or may initialize a value of a memory-access counter (e.g., set the memory-access counter to 1) in the newly created entry.

In some implementations, the host system may configure the memory system with certain parameters associated with tracking memory accesses using the ring-buffer structure 304 and/or the data structure 314. For example, the host system may selectively enable memory access tracking using the ring-buffer structure 304 and/or the data structure 314, the host system may set an aging factor and/or an epoch duration associated with the ring-buffer structure 304 and/or the data structure 314 (described in more detail below in connection with FIG. 3G), the host system may set a tracking granularity associated with the ring-buffer structure 304 and/or the data structure 314 (e.g., a tracking granularity used to align incoming DPAs with page IDs, among other examples), the host system may set types of tracked memory requests (e.g., read and/or write requests, among other examples), the host system may set a threshold associated with the memory-access counters (e.g., a hotness threshold) in the data structure, and/or the host system may configure other settings associated with the ring-buffer structure 304 and/or the data structure 314. Additional aspects of the ring-buffer structure 304 and the data structure 314 are described below in connection with FIGS. 3B-3G.

More particularly, FIGS. 3B and 3C show how a memory system may track incoming access requests immediately following initialization of the ring-buffer structure 304 and/or initialization of the data structure 314 (e.g., when the portions 306 of the ring-buffer structure 304 do not yet store any page IDs and/or when the data structure 314 does not yet store any entries and/or associated memory-access counters). As shown in FIG. 3B, at this point in time the memory-access pointer 308 (which points to the first available portion 306 in the ring-buffer structure 304 for storing a page ID) may point to the first portion 306-1 of the ring-buffer structure 304, because no memory accesses have yet been tracked using the ring-buffer structure 304 and thus no page IDs have yet been stored in the ring-buffer structure 304. Moreover, the data-structure pointer 310 (which points to the last portion 306 scanned for building the data structure) may point to the start position 312 and/or may not point to any portions 306 of the ring-buffer structure 304, because no memory accesses have yet been added to the data structure 314.

In some implementations, the memory system may then receive a memory-access request 318 (e.g., a CXL.mem request), identified by a DPA (such as DPA_{K} in the example depicted in FIG. 3B), from the host system. The memory system may process the received memory-access request 318, such as by aligning (e.g., converting) the DPA to a corresponding page ID (e.g., page IDK). Moreover, as shown in FIG. 3C, and as indicated by arrow 320, the memory system may store the page ID (e.g., page IDK) in a portion 306 of the ring-buffer structure pointed to by the memory-access pointer 308 at a point in time when the memory-access request 318 was received (e.g., the first portion 306-1 of the ring-buffer structure 304, as described above in connection with FIG. 3B) as indicated by arrow 320. The memory system may then advance the memory-access pointer 308 such that the memory-access pointer 308 points to the next available portion 306 of the ring-buffer structure (e.g., the second portion 306-2 of the ring-buffer structure 304, as shown in FIG. 3C). Put another way, after the DPA is converted into the corresponding page ID (e.g., by applying the configured tracking granularity) and/or is stored inside the portion 306 of the ring-buffer structure 304 pointed by the memory-access pointer 308, the memory-access pointer 308 may be incremented such that it points to the next portion 306 of the ring-buffer structure 304. In implementations in which the memory system is configured to only track a certain type of memory accesses, such as only read accesses or only write accesses, if the incoming memory-access request 318 is associated with a memory access type that is not to be tracked, the memory system may omit aligning the DPA to a page ID and/or storing the corresponding page ID in a portion 306 of the ring-buffer structure 304.

Moreover, the memory system may be configured to periodically check the page IDs stored in the ring-buffer structure and/or create or update corresponding entries in the data structure 314 (e.g., the hotlist) for the page IDs, accordingly. For example, when a page ID is inserted in the ring-buffer structure 304, the memory system may check the data structure 314 to determine if the page ID is present in the data structure 314 (e.g., to check if the hotlist already includes an entry associated with the page ID). If there is already an entry associated with the page ID in the data structure 314 (sometimes referred to herein as a “hit”), a memory-access counter (e.g., a hotness counter) in the corresponding entry may be updated (e.g., incremented by 1). However, if there is no entry in the data structure 314 corresponding to the page ID (sometimes referred to herein as a “miss,” such as in the example shown in FIG. 3C), a new entry may be created in the data structure, and/or the memory system may store the page ID in the new entry, initialize a corresponding memory-access counter (e.g., set to 1) in the new entry, and/or initialize a corresponding hot flag (e.g., set to 0) in the new entry, as indicated by arrow 322. The memory system may then compare the memory-access counter with a configured threshold (e.g., the configured hotness threshold). If the memory-access counter satisfies the threshold, the hot flag may be set to 1, indicating that the corresponding page ID is “hot.” On the other hand, if the memory-access counter does not satisfy the threshold, the hot flag may be set to 0, indicating that the corresponding page ID is not “hot.” Additionally, or alternatively, after processing a given portion 306 of the ring-buffer structure 304 (e.g., after scanning the portion 306 of the ring-buffer structure 304 and updating a corresponding entry in the data structure 314 and/or creating a new entry in the data structure 314 as described above), the data-structure pointer 310 may be advanced to the next position (e.g., the next portion 306) within the ring-buffer structure 304.

In some implementations, the memory system may be configured to overwrite page IDs stored in portions 306 of the ring-buffer structure 304, such as in implementations in which all portions 306 of the ring-buffer structure 304 are full (e.g., contain page IDs) and a subsequent memory-access request is received from the host system (sometimes referred to herein as a ring-buffer wrap-up procedure). More particularly, as shown in FIG. 3D by using hatching, at a certain point in time all portions 306 (e.g., portions 306-1 through 306-16) of the ring-buffer structure 304 may be full (e.g., may be used for storing a corresponding page ID). For example, at a point in time when the memory-access pointer 308 points to the final open portion 306 (e.g., the sixteenth portion 306-16) of the ring-buffer structure 304, the memory system may receive an incoming memory-access request 324, such as an incoming memory-access request associated with DPA_{Y}, as shown in FIG. 3D. Accordingly, the memory system may store a corresponding page ID (e.g., page ID_{Y}) in the sixteenth portion 316-16 of the ring-buffer structure 304, and the memory-access pointer 308 may be advanced such that it points to the next portion 306 of the ring-buffer structure 304 (e.g., the first portion 306-1), in a similar manner as described above in connection with FIGS. 3A-3C. More generally, when the memory-access pointer 308 reaches the last entry of the ring-buffer structure 304 (e.g., portion 316-16 in the example shown in FIG. 3D), and a new page ID is stored in this last empty entry, the memory-access pointer 308 is incremented, resulting in the memory-access pointer 308 advancing past the start position 312 of the ring-buffer structure 304. This corresponds to the operation flow for the ring-buffer wrap-up procedure, whereby after storing the page ID in the last free entry, the memory-access pointer 308 is incremented and points to the first ring-buffer entry.

Following this wrap-around event, when another memory-access request arrives, such as memory-access request 326 shown in FIG. 3D as being associated with DPA_{Z}, a page ID corresponding to the incoming memory-access request 326 (e.g., page ID_{Z}) may be stored within the first ring-buffer entry (e.g., the first portion 306-1 of the ring-buffer structure 304), effectively overwriting the page ID that was previously stored within that specific location of the ring-buffer structure 304. Optionally, when this wrap-up occurs, an overflow signal may be transmitted to a host system, as schematically indicated using arrow 332, and/or or an overflow counter may be updated to indicate that the memory-access pointer 308 has completed a full cycle and/or to indicate that a previously stored page ID has been overwritten in the ring-buffer structure 304.

Moreover, during wrapping up of the ring-buffer structure 304, if insertion of data into the data structure 314 is slower than the rate of incoming memory-access requests and/or if the memory system otherwise experiences a significant delay associated with tracking page IDs in the ring-buffer structure 304 using the data structure 314 (e.g., the hotlist), the memory-access pointer 308 may overtake the data-structure pointer 310 (e.g., may point to a portion 306 of the ring-buffer structure 304 that stores a page ID that has not yet been tracked and/or counted in the data structure 314). In this situation, the memory system may overwrite the older page ID stored at a portion of ring-buffer structure 304 with a new page ID before the older page ID has been processed and added to the data structure 314. Such an event could lead to the loss of tracking information for the overwritten page ID. In such implementations, the memory system may transmit an indication to the host system (sometimes referred to herein as asserting an overrun alarm) and/or may otherwise alert the host system that certain page IDs have not been accurately tracked and/or counted.

Put another way, in some implementations, if a new memory-access request arrives in a situation in which the page ID associated with the new memory-access request overwrites an older page ID stored at portion of the ring-buffer structure 304 (resulting in loss of tracking information for the older page ID since that page ID has not yet been parsed and inserted in the data structure 314), the memory system may assert an overrun notification and/or alarm. In some implementations, the overrun notification and/or alarm may remain active until the data-structure pointer 310 catches up to the portion 306 immediately preceding the memory-access pointer 308.

Additionally, or alternatively, this overrun state may prompt an associated flag to be set or reset. Additionally, or alternatively, in some implementations, the memory system may track (e.g., tally) a total quantity of DPAs and/or page IDs that have been missed in the tracking while the overrun notification is active, such as for a purpose of accounting for the lost tracking instances.

In some implementations, the memory system may evict an entry from the data structure 314, such as implementations in which a page ID present in the ring-buffer structure 304 does not already have an associated entry in the data structure 314 (e.g., the hotlist) and the data structure 314 is otherwise full. More particularly, as shown in FIG. 3E, the memory system may receive a memory-access request 334, such as a request associated with DPA_{L} in this example, and/or the memory system may store a corresponding page ID (e.g., page ID_{L}) in a portion 306 of the ring-buffer structure 304 (e.g., the twelfth portion 306-12 in this example), in a similar manner as described above in connection with FIGS. 3A-3D. Moreover, when the data-structure pointer 310 reaches the corresponding entry in the ring-buffer structure 304 (e.g., the twelfth portion 306-12 of the ring-buffer structure 304), the memory system may either update (e.g., increment) an associated counter in the data structure 314 or else create an entry for the corresponding page ID (e.g., page IDI, in this example), as described above in connection with FIGS. 3A-3D.

However, in this instance there is no entry in the data structure 314 corresponding to the page ID_{L} and the data structure 314 is otherwise full (e.g., there are no open entries in the data structure 314 for adding an entry associated with page ID_{L}). Accordingly, in such instances (e.g., when accommodating a new page in the ring-buffer structure 304 when there are no available slots in the data structure 314), the memory system may use a configured eviction policy to determine which existing entry in the data structure 314 to evict. For example, the memory system may use one of a least recently used (LRU) eviction policy, a least frequently used (LFU) eviction policy, a random eviction policy, and/or a similar eviction policy. As shown in FIG. 3E, using the configured eviction policy, the memory system determines that an entry associated with page ID_{X} is to be evicted, and thus the memory system may evict the corresponding entry, such as by overwriting in the data structure 314 the data associated with page ID_{X} (e.g., the page ID_{X}, a memory-access counter associated with page ID_{X}, and/or a hot flag associated with the page ID_{X}) with data associated with page IDI. (e.g., the page ID_{L}, a memory-access counter associated with page ID_{L}, and/or a hot flag associated with the page ID_{L}). In some implementations, using such a configured eviction policy may enable maintaining a dynamically updated list of hot pages and/or optimizing memory utilization.

In some implementations, the memory system may be configured to periodically report the various memory-access counters (e.g., hotness counters) and/or a subset thereof to the host system. For example, as shown in FIG. 3F, the memory system may receive a hotlist read request 340 from the host system, which may be a request to read memory-access counters in the data structure 314 (e.g., the hotlist) that satisfy a hotness threshold (e.g., a request to read memory-access counters for which a corresponding hot flag has been set). In such implementations, when the hotlist read request 340 is received by the memory system, the memory system may initiate a data structure 314 reading process. Accordingly, and as indicated by arrow 342, the data structure 314 entries may be parsed for hot flags (e.g., the hot flag bit of each entry in the hotlist may be checked). For each entry where the hot flag is set to 0 (e.g., indicating that the associated memory-access counter does not satisfy a threshold), the details of that entry (e.g., the page ID and associated memory-access counter value) may not be sent to the host system, as shown by reference number 344 in connection with page IDM. However, for each entry where the hot flag is set to 1 (e.g., indicating that the associated memory-access counter does satisfy a threshold), the respective page ID and memory-access counter for that entry may be transmitted to the host system, as shown by reference number 344 in connection with page IDK and page ID_{L}. This selective transmission may ensure that only the relevant (e.g., hot data entries) are communicated to the host system.

Additionally, or alternatively, in some implementations the memory system may report the hot entries to the host system by transmitting a list of identifier (e.g., page ID) and memory-access counter pairs. In such implementations, the list of pairs may be organized in descending order of memory-access counter values, providing an optimized and efficient overview of the hotlist entries to the host system.

In some implementations, the memory system may be configured (e.g., by the host system) to age the memory-access counters stored in the data structure 314, such as by aging the memory-access counters at an end of an epoch (e.g., a period of time associated with the ring-buffer structure 304 and/or the data structure 314 that is configured by the host system for tracking memory accesses). For example, FIG. 3G schematically illustrates an operation flow for hotlist aging used in detecting hot data within a memory controller system, such as a memory system that implements the CXL interconnect standard.

As indicated by reference number 346, the memory system may determine the end of an epoch duration. Subsequently, each filled entry of the data structure 314 (e.g., the hotlist), and more particularly each memory-access counter of each filled entry of the data structure 314, may be aged according to a configured aging factor, as shown by reference number 348. For example, at the end of an epoch, the counters associated with each page ID (e.g., Counter_{K}, Counter_{L}, and Counter_{M} in the example shown in FIG. 3G) may be halved with rounding-up (as one example of an aging factor), as shown by the transition of the respective counter values (e.g., 17 to 9 for page IDK, 22 to 11 for page ID_{L}, and/or 13 to 7 for page IDM). Additionally, or alternatively, in some implementations, if the aging process results in any memory-access counter being set to 0, the entry in the data structure 314 corresponding to that memory-access counter may be cleared and/or removed from the data structure 314. In such implementations, removing entries from the data structure 314 for which corresponding memory-access counters have been aged to 0 may prevent unnecessary consumption of data structure 314 space that otherwise would be used for tracking memory access requests that have occurred in the past. In some aspects, the aging mechanism may ensure maintenance of relevant hot data detection by reducing the weight of older memory access instances. Additionally, or alternatively, the aging mechanism may ensure that the memory system prioritizes recent access patterns, thereby facilitating efficient and dynamic memory management. In some implementations, the aging feature reflects an intelligent approach to memory access pattern tracking within the evolving field of memory controller technologies.

As indicated above, FIGS. 3A-3G are provided as an example. Other examples may differ from what is described with regard to FIGS. 3A-3G.

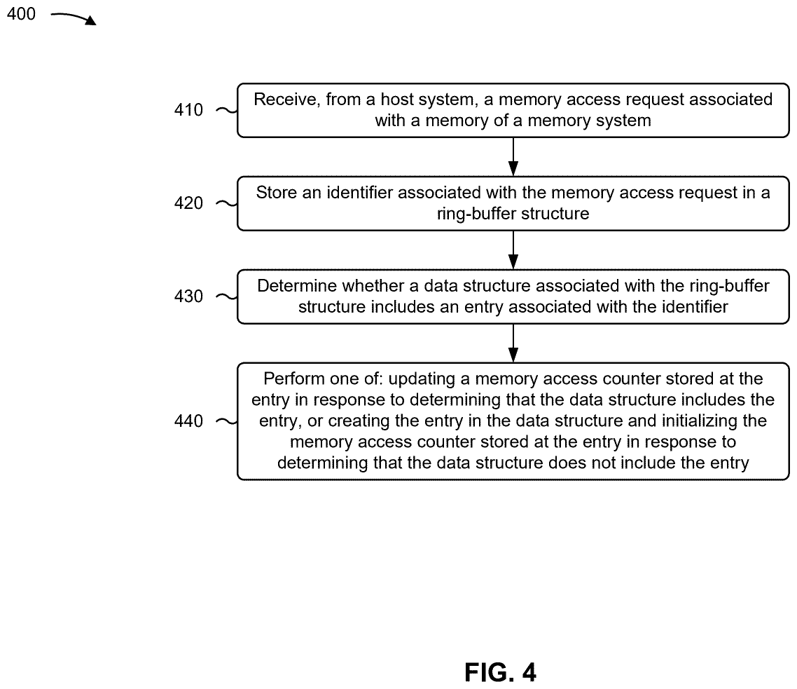

FIG. 4 is a flowchart of an example method 400 associated with tracking accesses to a memory using a ring-buffer structure. In some implementations, a memory system controller (e.g., the memory system controller 115 and/or main management subsystem 214) of a memory system (e.g., memory system 110 and/or CXL compliant memory system 204) may perform or may be configured to perform the method 400. In some implementations, another device or a group of devices separate from or including the memory system controller (e.g., one or more local controllers 125 and/or a local controller associated with CXL device attached memory 218) may perform or may be configured to perform the method 400. Thus, means for performing the method 400 may include the memory system controller, one or more local controllers, and/or one or more components of the memory system controller and/or one or more local controllers. Additionally, or alternatively, a non-transitory computer-readable medium may store one or more instructions that, when executed by the memory system controller, cause the memory system controller to perform the method 400.

As shown in FIG. 4, the method 400 may include receiving, from a host system, a memory-access request associated with a memory of a memory system (block 410). For example, the CXL compliant memory system 204 may receive one of the memory-access requests (e.g., one of memory-access requests 302, 318, 324, 326, 334) described above in connection with FIGS. 3A-3G.

As further shown in FIG. 4, the method 400 may include storing an identifier associated with the memory-access request in a ring-buffer structure (block 420). For example, the main management subsystem 214 of the CXL compliant memory system 204 may store a page ID associated with the memory request in a portion 306 of the ring-buffer structure 304, as described above in connection with FIGS. 3A-3G.

As further shown in FIG. 4, the method 400 may include determining whether a data structure associated with the ring-buffer structure includes an entry associated with the identifier (block 430). For example, the main management subsystem 214 of the CXL compliant memory system 204 may determine whether the data structure 314 (e.g., the hotlist) associated with the ring-buffer structure 304 includes an entry associated with page ID associated with the memory-access request, as described above in connection with FIGS. 3A-3G.

As further shown in FIG. 4, the method 400 may include performing one of: updating a memory-access counter stored at the entry in response to determining that the data structure includes the entry, or creating the entry in the data structure and initializing the memory-access counter stored at the entry in response to determining that the data structure does not include the entry (block 440). For example, the main management subsystem 214 of the CXL compliant memory system 204 may update a memory-access counter (e.g., a hotness counter) associated with a stored at the entry of the data structure 314 (e.g., the hotlist) in response to determining that the data structure includes the entry associated with the page ID, as described above in connection with FIGS. 3A-3G. Alternatively, the main management subsystem 214 of the CXL compliant memory system 204 may create an entry in the data structure 314 (e.g., the hotlist) and/or may initialize the memory-access counter (e.g., the hotness counter) stored at the entry in response to determining that the data structure does not include the entry, as described above in connection with FIGS. 3A-3G.

The method 400 may include additional aspects, such as any single aspect or any combination of aspects described below and/or described in connection with one or more other methods or operations described elsewhere herein.

In a first aspect, the method 400 includes determining whether the memory-access counter satisfies a threshold, and performing one of setting a flag in the entry in response to determining that the memory-access counter satisfies the threshold, or omitting setting the flag in the entry in response to determining that the memory-access counter does not satisfy the threshold. For example, the main management subsystem 214 of the CXL compliant memory system 204 may selectively set the hot flag or omit setting the hot flag in an entry in the data structure (e.g., the hotlist) depending on whether a corresponding hotness counter in the entry satisfies a threshold, as described above in connection with FIGS. 3A-3G.

In a second aspect, alone or in combination with the first aspect, the memory-access request is associated with at least one of a read request or a write request. For example, the main management subsystem 214 of the CXL compliant memory system 204 may be configured to selectively track read requests and/or write requests, as described above in connection with FIGS. 3A-3G.

In a third aspect, alone or in combination with one or more of the first and second aspects, the method 400 includes receiving, by the memory system controller and from the host system, configuration information that indicates at least one of an indication enabling tracking of one or more memory-access requests by the memory system, an aging factor associated with tracking the one or more memory-access requests by the memory system, an epoch duration associated with tracking the one or more memory-access requests by the memory system, a tracking granularity associated with tracking the one or more memory-access requests by the memory system, one or more memory-access request types that are to be tracked by the memory system, or a memory-access counter threshold associated with tracking the one or more memory-access requests by the memory system. For example, the main management subsystem 214 of the CXL compliant memory system 204 may receive, from the CXL host 202, an indication of the configuration information described above in connection with FIGS. 3A-3G.

In a fourth aspect, alone or in combination with one or more of the first through third aspects, the ring-buffer structure is associated with a memory-access pointer and a data-structure pointer, wherein storing the identifier in the ring-buffer structure includes storing the identifier in a portion of the ring-buffer structure that is indicated to by the memory-access pointer, and wherein determining whether the data structure includes the entry associated with the identifier includes determining whether the data structure includes the entry when the data-structure pointer indicates the portion of the ring-buffer structure. For example, the ring-buffer structure 304 may be associated with the memory-access pointer 308 and/or the data-structure pointer 310 described above in connection with FIGS. 3A-3G.

In a fifth aspect, alone or in combination with one or more of the first through fourth aspects, storing the identifier in the ring-buffer structure includes storing the identifier in a portion of the ring-buffer structure by overwriting another identifier that is stored in the portion of the ring-buffer structure. For example, the main management subsystem 214 of the CXL compliant memory system 204 may overwrite a page ID in a portion 306 of the ring-buffer structure 304, as described above in connection with FIG. 3D.

In a sixth aspect, alone or in combination with one or more of the first through fifth aspects, the method 400 includes at least one of transmitting, to the host system, an indication that the other identifier has been overwritten in the portion of the ring-buffer structure, or updating an overflow counter associated with ring-buffer structure based on overwriting the other identifier in the portion of the ring-buffer structure. For example, the main management subsystem 214 of the CXL compliant memory system 204 may transmit the overflow signal described above in connection with arrow 332 of FIG. 3D and/or may update an overflow counter as described above in connection with FIG. 3D based on overwriting the other page ID in the portion 306 of the ring-buffer structure 304.

In a seventh aspect, alone or in combination with one or more of the first through sixth aspects, the method 400 includes determining, by the memory system controller, that a memory access associated with the other identifier has not yet been tracked using the data structure, and transmitting, by the memory system controller and to the host system, an indication that the other identifier has been overwritten without being tracked in the data structure. For example, the main management subsystem 214 of the CXL compliant memory system 204 may transmit, to the CXL host 202, an overrun alarm indicating that a certain page ID has been overwritten without being tracked in the data structure 314 (e.g., the hotlist), as described above in connection with FIG. 3D.

In an eighth aspect, alone or in combination with one or more of the first through seventh aspects, creating the entry in the data structure includes evicting another entry from the data structure. For example, the main management subsystem 214 of the CXL compliant memory system 204 may evict an entry in the data structure 314 (e.g., the hotlist) when adding a new entry to the data structure 314 when the data structure is otherwise full, as described above in connection with FIG. 3E.

In a ninth aspect, alone or in combination with one or more of the first through eighth aspects, evicting the other entry from the data structure includes evicting the other entry based on at least one of a least recently used eviction policy, a least frequently used eviction policy, or a random eviction policy. For example, the main management subsystem 214 of the CXL compliant memory system 204 may use an eviction policy configured by the CXL host 202 to evict an entry from the data structure 314 (e.g., the hotlist), as described above in connection with FIG. 3E.

In a tenth aspect, alone or in combination with one or more of the first through ninth aspects, the method 400 includes receiving, by the memory system controller and from the host system, a request to read data from the data structure, determining, by the memory system controller, one or more entries in the data structure for which a respective flag has been set, and transmitting, by the memory system controller and to the host system, an indication of a respective identifier and a respective memory-access counter for each entry for which the respective flag has been set. For example, the main management subsystem 214 of the CXL compliant memory system 204 may determine which entries are to be reported to the CXL host 202 based on whether a hot flag has been set in the corresponding entry in the data structure 314 (e.g., the hotlist), and, for the entries to be reported, the main management subsystem 214 of the CXL compliant memory system 204 may transmit, to the CXL host 202, an indication of a respective identifier (e.g., page ID) and a respective memory-access counter (e.g., hotness counter), as described above in connection with FIG. 3F.

In an eleventh aspect, alone or in combination with one or more of the first through tenth aspects, transmitting the indication of the respective identifier and the respective memory-access counter for each entry for which the respective flag has been set includes transmitting, by the memory system controller and to the host system, a list of one or more identifier and memory-access counter pairs, and wherein the list of one or more identifier and memory-access counter pairs is sorted according to a descending order of memory-access counter values. For example, the main management subsystem 214 of the CXL compliant memory system 204 may sort the reported entries in descending order of access counter values, as described above in connection with FIG. 3F.

In a twelfth aspect, alone or in combination with one or more of the first through eleventh aspects, the method 400 includes determining, by the memory system controller, that an epoch duration has elapsed, and aging, by the memory system controller, one or more memory-access counters stored in the data structure based on determining that the epoch duration has elapsed. For example, the main management subsystem 214 of the CXL compliant memory system 204 may age the access counter values (e.g., hotness counter values) stored in the data structure 314 (e.g., the hotlist) at the end of an epoch, as described above in connection with FIG. 3G.

In a thirteenth aspect, alone or in combination with one or more of the first through twelfth aspects, aging the one or more memory-access counters includes aging the one or more memory-access counters based on an aging factor. For example, the main management subsystem 214 of the CXL compliant memory system 204 may use an aging factor configured by the CXL host 202 to age the access counter values (e.g., the hotness counter values) in the data structure 314 (e.g., the hotlist) at the end of the epoch, as described above in connection with FIG. 3G.

In a fourteenth aspect, alone or in combination with one or more of the first through thirteenth aspects, the ring-buffer structure is associated with a fixed-size data-structure including multiple portions logically arranged in a circular manner from a first portion to a last portion, identifiers for received memory-access requests are sequentially stored in the fixed-size data-structure from the first portion to the last portion, and the fixed-size data structure is managed in a first-in-first-out (FIFO) manner such that, following storage of an identifier in the last portion, an identifier associated with a next-received memory-access request is stored in the first portion. For example, the ring-buffer structure may be the ring buffer structure 304 including the multiple portions 306 that are logically arranged in a circular manner and used to store page IDs in a FIFO manner such that, once a page ID is stored in the sixteenth portion 306-16, a page ID associated with a next-received memory-access request is stored in the first portion 306-1, as described above in connection with FIG. 3D.

Although FIG. 4 shows example blocks of a method 400, in some implementations, the method 400 may include additional blocks, fewer blocks, different blocks, or differently arranged blocks than those depicted in FIG. 4. Additionally, or alternatively, two or more of the blocks of the method 400 may be performed in parallel. The method 400 is an example of one method that may be performed by one or more devices described herein. These one or more devices may perform or may be configured to perform one or more other methods based on operations described herein.

In some implementations, a memory system includes one or more components configured to: receive, from a host system, a memory-access request associated with a memory of the memory system; store an identifier associated with the memory-access request in a ring-buffer structure; determine whether a data structure associated with the ring-buffer structure includes an entry associated with the identifier; and perform one of: update a memory-access counter stored at the entry in response to determining that the data structure includes the entry, or create the entry in the data structure and initialize the memory-access counter stored at the entry in response to determining that the data structure does not include the entry.

In some implementations, a method includes receiving, by a memory system controller and from a host system, a memory-access request associated with a memory of a memory system; storing, by the memory system controller, an identifier associated with the memory-access request in a ring-buffer structure; determining, by the memory system controller, whether a data structure associated with the ring-buffer structure includes an entry associated with the identifier; and performing, by the memory system controller, one of: updating a memory-access counter stored at the entry in response to determining that the data structure includes the entry, or creating the entry in the data structure and initializing the memory-access counter stored at the entry in response to determining that the data structure does not include the entry.

In some implementations, a compute express link (CXL) compliant memory system includes one or more components configured to: receive, from a host system, a CXL.mem request associated with a memory of the CXL compliant memory system; store a page identifier (ID) associated with the CXL.mem request in a ring-buffer structure; determine whether a hotlist associated with the ring-buffer structure includes an entry associated with the page ID; and perform one of: update a hotness counter stored at the entry in response to determining that the hotlist includes the entry, or create the entry in the hotlist and initialize the hotness counter stored at the entry in response to determining that the hotlist does not include the entry.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, the terms “substantially” and “approximately” mean “within reasonable tolerances of manufacturing and measurement.” As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory system, comprising:
one or more components configured to:
receive, from a host system, a memory-access request associated with a memory of the memory system;
store an identifier associated with the memory-access request in a ring-buffer structure;
determine whether a data structure associated with the ring-buffer structure includes an entry associated with the identifier; and
perform one of:
update a memory-access counter stored at the entry in response to determining that the data structure includes the entry, or
create the entry in the data structure and initialize the memory-access counter stored at the entry in response to determining that the data structure does not include the entry.

2. The memory system of claim 1, wherein the one or more components are further configured to:
determine whether the memory-access counter satisfies a threshold; and
perform one of:
set a flag in the entry in response to determining that the memory-access counter satisfies the threshold, or
omit setting the flag in the entry in response to determining that the memory-access counter does not satisfy the threshold.

3. The memory system of claim 1, wherein the memory-access request is associated with at least one of a read request or a write request.

4. The memory system of claim 1, wherein the one or more components are further configured to receive, from the host system, configuration information that indicates at least one of:
an indication enabling tracking of one or more memory-access requests by the memory system,
an aging factor associated with tracking the one or more memory-access requests by the memory system,
an epoch duration associated with tracking the one or more memory-access requests by the memory system,
a tracking granularity associated with tracking the one or more memory-access requests by the memory system,
one or more memory-access request types that are to be tracked by the memory system, or
a memory-access counter threshold associated with tracking the one or more memory-access requests by the memory system.

5. The memory system of claim 1, wherein the ring-buffer structure is associated with a memory-access pointer and a data-structure pointer,
wherein the one or more components, to store the identifier in the ring-buffer structure, are configured to store the identifier in a portion of the ring-buffer structure that is indicated to by the memory-access pointer, and
wherein the one or more components, to determine whether the data structure includes the entry associated with the identifier, are configured to determine whether the data structure includes the entry when the data-structure pointer indicates the portion of the ring-buffer structure.

6. The memory system of claim 1, wherein the one or more components, to store the identifier in the ring-buffer structure, are configured to store the identifier in a portion of the ring-buffer structure by overwriting another identifier that is stored in the portion of the ring-buffer structure.

7. The memory system of claim 6, wherein the one or more components are further configured to at least one of:
transmit, to the host system, an indication that the other identifier has been overwritten in the portion of the ring-buffer structure, or
update an overflow counter associated with ring-buffer structure based on overwriting the other identifier in the portion of the ring-buffer structure.

8. The memory system of claim 6, wherein the one or more components are further configured to:
determine that a memory access associated with the other identifier has not yet been tracked using the data structure; and
transmit, to the host system, an indication that the other identifier has been overwritten without being tracked in the data structure.

9. The memory system of claim 1, wherein the one or more components, to create the entry in the data structure, are configured to evict another entry from the data structure.

10. The memory system of claim 9, wherein the one or more components, to evict the other entry from the data structure, are configured to evict the other entry based on at least one of:
a least recently used eviction policy,
a least frequently used eviction policy, or
a random eviction policy.

11. The memory system of claim 1, wherein the one or more components are further configured to:
receive, from the host system, a request to read data from the data structure;
determine one or more entries in the data structure for which a respective flag has been set; and
transmit, to the host system, an indication of a respective identifier and a respective memory-access counter for each entry for which the respective flag has been set.

12. The memory system of claim 11, wherein the one or more components, to transmit the indication of the respective identifier and the respective memory-access counter for each entry for which the respective flag has been set, are configured to transmit, to the host system, a list of one or more identifier and memory-access counter pairs, and
wherein the list of one or more identifier and memory-access counter pairs is sorted according to a descending order of memory-access counter values.

13. The memory system of claim 1, wherein the one or more components are further configured to:
determine that an epoch duration has elapsed; and
age one or more memory-access counters stored in the data structure based on determining that the epoch duration has elapsed.

14. The memory system of claim 13, wherein the one or more components, to age the one or more memory-access counters, are configured to age the one or more memory-access counters based on an aging factor.

15. The memory system of claim 1, wherein the ring-buffer structure is associated with a fixed-size data-structure including multiple portions logically arranged in a circular manner from a first portion to a last portion,
wherein identifiers for received memory-access requests are sequentially stored in the fixed-size data-structure from the first portion to the last portion, and
wherein the fixed-size data structure is managed in a first-in-first-out manner such that, following storage of an identifier in the last portion, an identifier associated with a next-received memory-access request is stored in the first portion.

16. A method, comprising:
receiving, by a memory system controller and from a host system, a memory-access request associated with a memory of a memory system;
storing, by the memory system controller, an identifier associated with the memory-access request in a ring-buffer structure;
determining, by the memory system controller, whether a data structure associated with the ring-buffer structure includes an entry associated with the identifier; and
performing, by the memory system controller, one of:
updating a memory-access counter stored at the entry in response to determining that the data structure includes the entry, or
creating the entry in the data structure and initializing the memory-access counter stored at the entry in response to determining that the data structure does not include the entry.

17. The method of claim 16, further comprising:
determining, by the memory system controller, whether the memory-access counter satisfies a threshold; and
performing, by the memory system controller, one of:
setting a flag in the entry in response to determining that the memory-access counter satisfies the threshold, or
omitting setting the flag in the entry in response to determining that the memory-access counter does not satisfy the threshold.

18. The method of claim 16, further comprising receiving, by the memory system controller and from the host system, configuration information that indicates at least one of:
an indication enabling tracking of one or more memory-access requests by the memory system,
an aging factor associated with tracking the one or more memory-access requests by the memory system,
an epoch duration associated with tracking the one or more memory-access requests by the memory system,
a tracking granularity associated with tracking the one or more memory-access requests by the memory system,
one or more memory-access request types that are to be tracked by the memory system, or
a memory-access counter threshold associated with tracking the one or more memory-access requests by the memory system.

19. The method of claim 16, wherein storing the identifier in the ring-buffer structure includes storing the identifier in a portion of the ring-buffer structure by overwriting another identifier that is stored in the portion of the ring-buffer structure.

20. The method of claim 16, further comprising:
receiving, by the memory system controller and from the host system, a request to read data from the data structure;
determining, by the memory system controller, one or more entries in the data structure for which a respective flag has been set; and
transmitting, by the memory system controller and to the host system, an indication of a respective identifier and a respective memory-access counter for each entry for which the respective flag has been set.
